(19) United States
(12) Patent Application Publication
(10) Pub. No.: US 2010/0260472 A1
(43) Pub. Date: Oct. 14, 2010

(54) VIDEO RECORDING AND REPRODUCING APPARATUS AND CONTROL METHOD THEREOF

(75) Inventor: Koichi Okada, Kunitachi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/755,686

(22) Filed: Apr. 7, 2010

(30) Foreign Application Priority Data
Apr. 13, 2009 (JP) 2009-097107

(51) Int. Cl. H04N 5/91

(52) U.S. Cl. 386/68; 386/E05.003

(57) ABSTRACT

An apparatus includes a recording unit configured to record in a recording mode in which recording is started by a recording start instruction and is stopped after a predetermined recording time elapses, a changing unit configured to change a number of frames to be recorded per unit time, and a setting unit configured to set, when an image recorded in the recording mode is reproduced, the predetermined recording time according to reproduction speed so that reproduction time of the image becomes constant.

### BACKGROUND OF THE INVENTION

1. Field of the Invention

The present invention relates to video recording and reproducing apparatus which records and reproduces video data and control method thereof.

2. Description of the Related Art

A slide show technique is widely known in which images recorded using a digital camera are displayed and reproduced by sequentially updating the images. Various types of slide show techniques are practically used, such as sequentially or randomly displaying images, and adding effects or music to the images.

The slide show is often used to reproduce still image data. However, there are digital cameras capable of recording moving image data in addition to still image data. In such a case, the slide show is performed by a mixture of still image data and moving image data.

On the other hand, cameras such as a video camera which mainly capture moving images employ a simple reproduction method, compared with the still image data reproduction method, such as only sequentially reproducing moving image data, or reproducing moving images which are bookmarked in a playlist. Since lengths of the captured video images are not uniform and video images may include a part not required to be reproduced, it becomes necessary to edit the video images before reproduction. It is thus less capable of fully displaying effectiveness of reproduction, and only a simple reproduction method is employed as a result.

To solve such a problem, Japanese Patent Application Laid-Open No. 06-153028 discusses a video camera which records video images for a predetermined time and is put into practical use. Such a video camera automatically stops recording after a determined time has elapsed from when a user started recording, so that the video images are reproduced at constant intervals even without editing. The video images can thus be reproduced at constant intervals along with music, similarly as in the still image slide show.

However, in such a video camera which records images for a predetermined time, constant reproduction time is achieved only when the recording time is constant. As a result, if the video camera can record a slow motion image or a quick motion image, the reproduction time of the slow motion image becomes long and the reproduction time of the quick motion image becomes short when the video images are recorded for a predetermined time.

### SUMMARY OF THE INVENTION

According to an aspect of the present invention, a recording and reproducing apparatus includes a recording unit configured to record in a recording mode in which video recording is started by a recording start instruction and is stopped after a predetermined recording time elapses, a changing unit configured to change a number of frames to be recorded per unit time and a setting unit configured to set, when a video image recorded in the recording mode is reproduced, the predetermined recording time according to a reproduction speed so that reproduction time of the video image becomes constant.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of a video recording and reproducing apparatus according to a first exemplary embodiment of the present invention.

FIG. 2 illustrates a relation among captured data, recording data, and reproduction data of a video image to be reproduced at a normal speed.

FIG. 3 illustrates a relation among captured data, recording data, and reproduction data of a slow motion image according to the first exemplary embodiment of the present invention.

FIG. 4 illustrates a relation among captured data, recording data, and reproduction data of a quick motion image according to the first exemplary embodiment of the present invention.

FIG. 5 illustrates an example of a slow motion setting screen.

FIG. 6 illustrates an example of a video recording time notification screen when specifying a slow motion setting.

FIG. 7 illustrates an example of a limited slow motion setting screen.

FIG. 8 illustrates an example of a video recording time notification screen for a slow motion setting.

FIG. 9 illustrates a relation among captured data, recording data, and reproduction data of a slow motion image according to a second exemplary embodiment of the present invention.

FIG. 10 illustrates a relation among captured data, recording data, and reproduction data of a quick motion image according to the second exemplary embodiment of the present invention.

FIG. 11 illustrates a relation among captured data, recording data, and reproduction data of a slow motion image according to a third exemplary embodiment of the present invention.

FIG. 12 illustrates a relation among captured data, recording data, and reproduction data of a quick motion image according to a third exemplary embodiment of the present invention.

### DESCRIPTION OF THE EMBODIMENTS

Various exemplary embodiments, features, and aspects of the invention will be described in detail below with reference to the drawings.

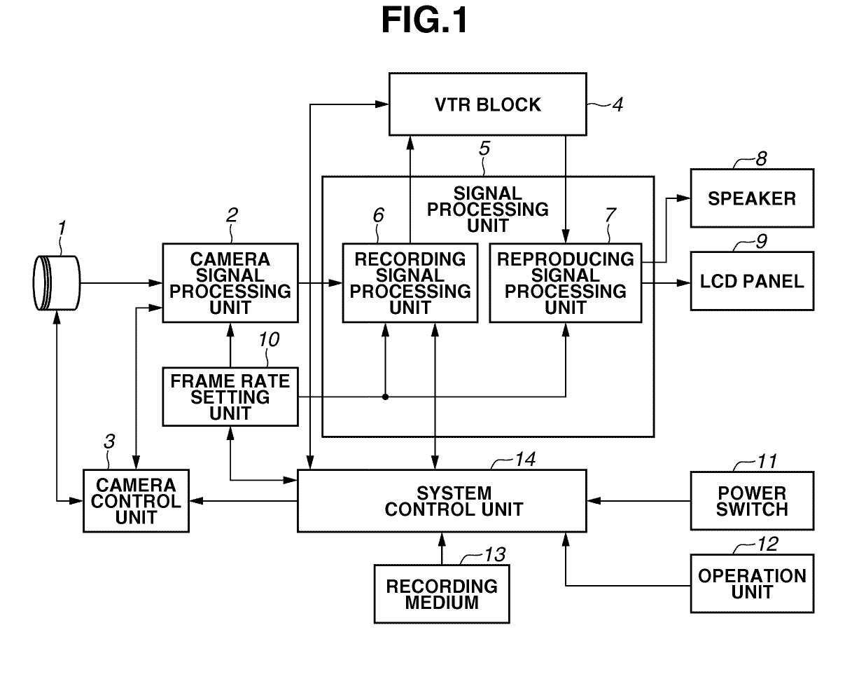

FIG. 1 is a block diagram illustrating an example of a configuration of a video recording and reproducing apparatus according to a first exemplary embodiment of the present invention. Referring to FIG. 1, an image pickup unit 1 includes an optical lens, an image sensor such as a charge-coupled device (CCD), an autofocus mechanism, and a zoom mechanism. The image pickup unit 1 performs focusing and adjusts light quantity with respect to an object according to an instruction from a camera control unit 3. The image pickup unit 1 then converts an optical image of the object formed through the lens to a video signal and outputs the video signal to a camera signal processing unit 2.

The camera control unit 3 includes a microcomputer and controls the entire camera system according to instructions from a system control unit 14 and an operation unit 12.

A frame rate setting unit 10 instructs the camera signal processing unit 2 on a frame rate of video data to be transferred to a recording signal processing unit 6 (hereinafter referred to as frame rate 1) by instruction from the system control unit 14. Further, the frame rate setting unit 10 instructs the recording signal processing unit 6 on a frame rate of video data to be recorded (hereinafter referred to as frame rate 2). Furthermore, the frame rate setting unit 10 instructs a reproducing signal processing unit 7 on a frame rate of video data to be reproduced (hereinafter referred to as frame rate 3). Such frame rates can be set independently, and contents of the settings can be switched by an operation on the operation unit 12 or selected from a setting screen such as a menu screen.

The camera signal processing unit 2 performs predetermined signal processing on the video signal output from the image pickup unit 1 according to instructions from the camera control unit 3 and the frame rate setting unit 10. The camera signal processing unit 2 then outputs the processed signal to the recording signal processing unit 6.

The signal processing unit 5 includes the recording signal processing unit 6 and the reproducing signal processing unit 7 and performs various recording and reproducing signal processing according to instructions from the system control unit 14. The recording signal processing unit 6 performs predetermined signal processing on the signal output from the camera signal processing unit 2 and outputs the result to a video tape recorder (VTR) block 4. The reproducing signal processing unit 7 performs predetermined processing on the signal reproduced from the VTR block 4 and outputs the result to a speaker 8. The reproducing signal processing unit 7 further adds character information and information for displaying a print range frame which are transmitted from the system control unit 14 to video signals and outputs the result to a liquid crystal display (LCD) panel 9.

The VTR block 4 includes a mechanical servo control unit which mainly includes a mechanical unit, a mechanical drive unit, and a microcomputer. The VTR block 4 performs recording and reproducing operations with respect to a recording medium 13 according to an instruction from the system control unit 14.

The LCD panel 9 displays to an operator the video signals and various pieces of information about the apparatus main body, guidance in setting the menu, and the print range frame using texts and codes.

A portion of the operation unit 12 includes switches for operating a VTR system and the entire apparatus (e.g., [↑], [→], [↓], [←], [SET], [END], [PRINT], [MENU], [PLAY], [FF/REW], [STOP], [START/STOP], [SELFTIMER], and the like). The operation unit 12 thus outputs an instruction from the operator to the system control unit 14. Further, a portion of the operation unit 12 includes various switches and dials for operating a camera system (e.g., autofocus (AF) on/off, auto-exposure (AE) auto/lock, program AE, zoom, and the like). The operation unit 12 thus outputs an instruction from the operator to the camera control unit 3.

A power switch 11 is used to select a power mode of the apparatus main body (i.e., camera/off/VTR) and outputs the selected status to the system control unit 14.

The system control unit 14 which includes the microcomputer integrally controls the above-described components.

The video recording and reproducing apparatus according to the first exemplary embodiment includes a speed changing unit which changes a number of frames to be recorded per unit time by changing a captured data amount input from the image pickup unit 1. A method for setting video recording time in the video recording and reproducing apparatus according to the first exemplary embodiment will be described below.

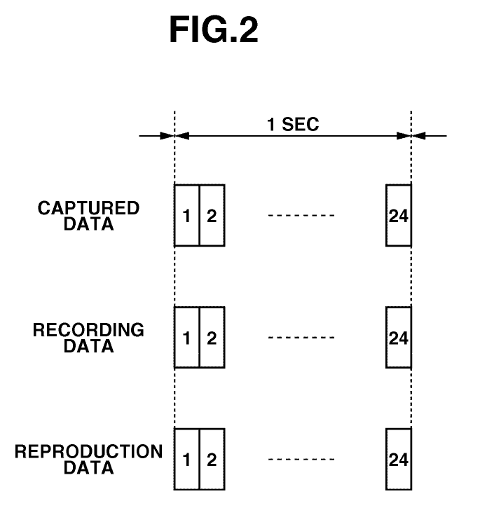

According to the present exemplary embodiment, the frame rate 2 and the frame rate 3 are the same values, and the frame rate 1 is the same value or a different value. FIGS. 2, 3, and 4 illustrate relations among the numbers of frames per unit time when data is recorded and reproduced at settings of the frame rate 1, frame rate 2, and frame rate 3.

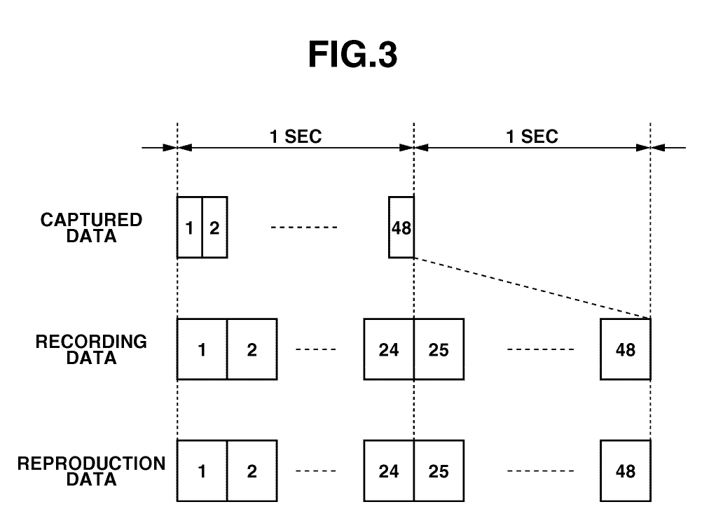

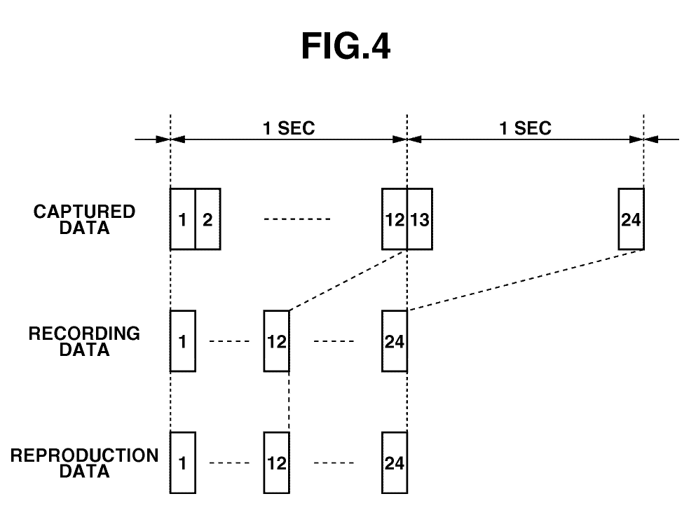

FIG. 2 illustrates a relation among the numbers of frames per unit time when a video image is recorded and reproduced at a normal speed. FIG. 3 illustrates a relation among the numbers of frames per unit time when a video image is recorded and reproduced at a double speed (i.e., recording and reproducing an image to be reproduced in slow motion at half the speed). FIG. 4 illustrates a relation among the numbers of frames per unit time when the video image is recorded and reproduced at half the speed (i.e., recording and reproducing an image to be reproduced in quick motion at a double speed).

In each of the drawings, “captured data” is data transferred from the camera signal processing unit 2 to the recording signal processing unit 6. Further, “recording data” is data recorded by the recording signal processing unit 6, and “reproduction data” is data read out when the reproducing signal processing unit 7 reproduces the image.

Referring to FIG. 2, when the apparatus records the video image at the normal speed, without changing recording speed and reproducing speed, a ratio between the frame rate 1 and the frame rate 2 is 1:1. The frame rate 2 and the frame rate 3 are the same values. Therefore, the number of frames acquired from the camera signal processing unit 2 per unit time, the number of frames recorded by the recording signal processing unit 6 per unit time, and the number of frames reproduced by the reproducing signal processing unit 7 per unit time match with each other. As a result, the video image of the normal speed can be recorded, i.e., the recording time and the reproduction time of the video image are the same.

In contrast, referring to FIG. 3, when the frame rate 1 is set to 48 fps and the frame rate 2 is set to 24 fps, the ratio between the frame rate 1 and the frame rate 2 becomes 2:1. Therefore, the number of frames acquired per unit time from the camera signal processing unit 2 is twice the number of frames recorded per unit time by the recording signal processing unit 6. In other words, the apparatus records twice the amount of the frames as compared to the video image of the normal speed. Since the frame rate 3 and the frame rate 2 are the same values, the time for reproducing the recorded image is also doubled. The image recorded as described above is thus reproduced in slow motion at half the speed.

Further, referring to FIG. 4, when the frame rate 1 is set to 12 fps and the frame rate 2 is set to 24 fps, the ratio between the frame rate 1 and the frame rate 2 becomes 1:2. Therefore, the number of frames acquired per unit time from the camera signal processing unit 2 is half the number of frames recorded per unit time by the recording signal processing unit 6. In other words, the apparatus records half the amount of frames as compared to the video image of the normal speed. Since the frame rate 3 and the frame rate 2 are the same values, the time for reproducing the recorded video is also halved. The image recorded as described above is thus reproduced in quick motion at the double speed.

The video recording and reproducing apparatus according to the present exemplary embodiment is capable of executing a recording mode which records video images by receiving a recording start instruction and a recording stop instruction from a user (hereinafter referred to as recording mode 1). The video recording and reproducing apparatus according to the present exemplary embodiment is also capable of executing a recording mode in which the user only instructs recording start, and the apparatus automatically stops recording after a predetermined time has elapsed (hereinafter referred to as recording mode 2). The user can switch between the recording mode 1 and the recording mode 2 by operating on the operation unit 12. The user can also switch between the modes using a menu setting. The operation performed in the recording mode 2 will be described below.

A recording time t in the recording mode 2 can be a unique setting value of the apparatus or can be selected from a plurality of setting values. When the frame rate 1 and the frame rate 2 are the same values, i.e., recording is performed at the normal speed, the apparatus automatically stops recording after the time t elapsed from start of recording. The lengths of all video images recorded as described above thus become the time t.

On the other hand, if the video image is to be recorded at N times the normal speed, the reproduction time becomes t*N when recording is performed for the time t. The video image is thus recorded by calculating a recording time t′ using an equation 1 described below (i.e., setting the recording time), so that the reproduction time of the video image to be recorded becomes the time t.

t′=t/N (equation 1)

For example, if the video image is to be recorded at double speed (i.e., a video image to be reproduced in the slow motion at half the speed is to be recorded), the recording time t′ of the video in the recording mode 2 becomes 8/2=4 seconds when the recording time at the normal speed is 8 seconds.

As described above, since the recording time t′ can be calculated using the equation 1, the user can record video images of constant lengths without considering the reproduction time of the recorded video images.

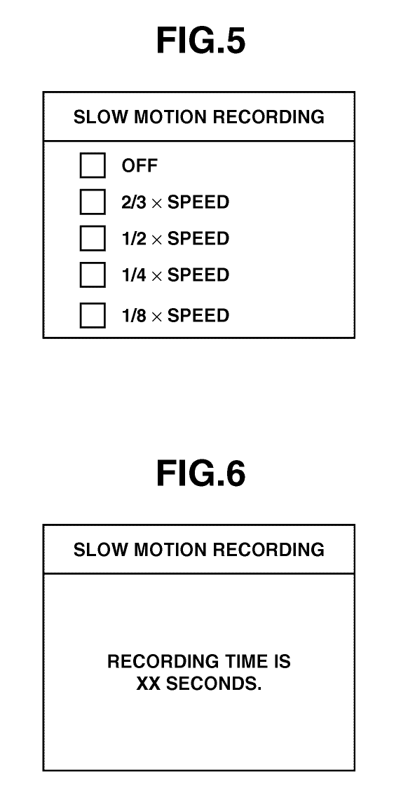

FIG. 5 illustrates an example of a menu screen used to set a reproduction speed of the video when a slow motion image is recorded (i.e., a slow motion setting screen). An “OFF” setting indicates that the video image is to be recorded at the normal speed, and “⅔”, “½”, “¼”, and “⅛” times the speed settings indicate ratios of the speed at which the video image will be reproduced with respect to the normal speed. Such settings illustrate an example of processing by a setting unit which sets a content changed by the speed changing unit.

FIG. 6 illustrates an example of a screen which notifies the user of the recording time t′ when recording the video image is performed in the recording mode 2 after changing the setting on the slow motion setting screen illustrated in FIG. 5.

When the user actually performs shooting, it is difficult to capture an image in an extremely short time, or it is wasteful for the user when the shooting time becomes drastically long. For example, if the slow motion recording is set to ⅛ of the speed when the recording time t is 4 seconds, the recording time t′ becomes 4/8=0.5 sec. However, it is often difficult to record a desired video image in 0.5 second.

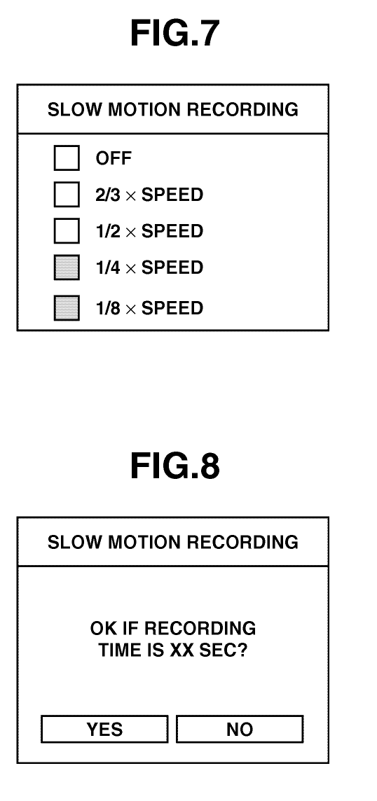

To solve such a problem, if the shooting time becomes extremely short, a restriction can be applied in the slow motion setting screen as illustrated in FIG. 7. More specifically, the user becomes restricted from selecting setting items which cause the recording time t′ to become inappropriate for shooting (i.e., restriction on a setting range). If it is not mandatory to restrict the setting range, a warning message may be displayed to the user as illustrated in FIG. 8 when the user is to select a setting exceeding the setting range. Further, if the setting exceeds the setting range, the apparatus may forcibly switch from the recording mode 2 to the recording mode 1, or can confirm that the recording mode is switched from the recording mode 2 to the recording mode 1 after warning the user, to realize a similar effect.

A restriction can also be applied on an operation when the recording mode 1 is switched to the recording mode 2. When the apparatus is recording a slow motion image in the recording mode 1, the recording time is not restricted, so that there is no restriction applied on the slow motion setting screen illustrated in FIG. 5. However, if the recording mode is switched from the recording mode 1 to the recording mode 2, the recording time t′ may be included in a range which is inappropriate for shooting depending on the content of the slow motion setting. In such a case, the user can be prohibited from switching the recording mode from the recording mode 1 to the recording mode 2. If it is not necessary to prohibit switching, the apparatus may display a message warning the user as illustrated in FIG. 8 when the recording mode 1 is switched to the recording mode 2, or after the setting has been changed.

The slow motion image is mainly described in the above example, and similar operations are performed when the quick motion image is recorded and reproduced.

A video recording and reproducing apparatus according to a second exemplary embodiment includes a speed changing unit which changes the number of frames recorded per unit time by performing frame conversion when data captured by the image pickup unit 1 is recorded. A method for setting video recording time of the video recording and reproducing apparatus according to the second exemplary embodiment will be described below.

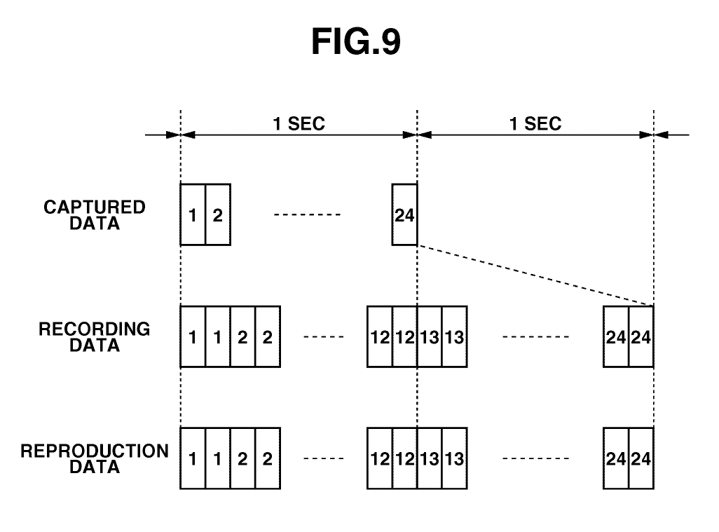

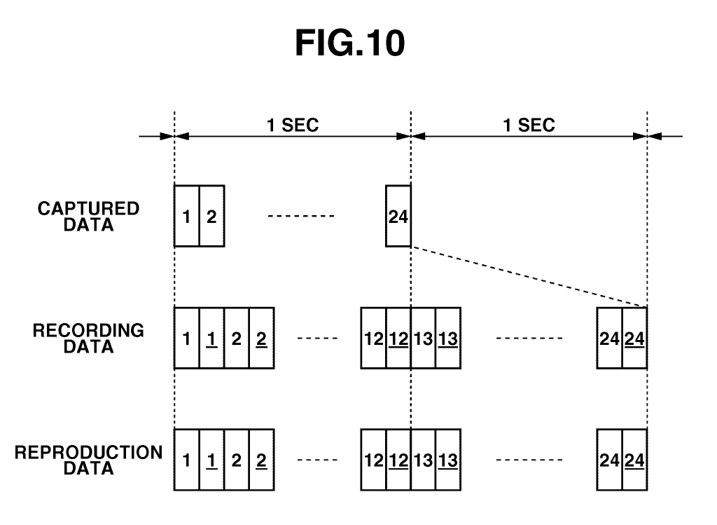

FIG. 9 illustrates a frame configuration when a video image to be reproduced in slow motion at half the normal speed is recorded and reproduced. Further, FIG. 10 illustrates a frame configuration when a video image to be reproduced in quick motion at double speed is recorded and reproduced.

According to the present exemplary embodiment, the frame rate 1, the frame rate 2, and the frame rate 3 are the same values. In FIGS. 9 and 10, “captured data” is data transferred from the camera signal processing unit 2 to the recording signal processing unit 6. Further, “recording data” is data recorded by the recording signal processing unit 6, and “reproduction data” is data read out by the reproducing signal processing unit 7 to reproduce the video image.

Referring to FIG. 9, the frame rates of the captured data, the recording data, and the reproduction data are 24 fps. When the data acquired at 24 fps is recorded, the recording signal processing unit 6 reads out the data a plurality of times and records the data, so that the amount of recording data becomes twice the amount of the captured data. This indicates that the actual frame rate has become half the original frame rate, and when the data is reproduced, a slow motion image is reproduced at half the speed. In the example illustrated in FIG. 9, the data is read out a plurality of times so that the frame rate of the recorded video image actually becomes half the original frame rate. However, the frame rate can be converted using other methods such as interpolating the data, which do not affect the result of the present invention.

Referring to FIG. 10, the frame rates of the captured data, the recording data, and the reproduction data are 24 fps. When the data acquired at 24 fps is recorded, the recording signal processing unit 6 thins out and records the data, so that the amount of the recording data becomes half the amount of the captured data. This indicates that the actual frame rate has become twice the original frame rate, and when the data is reproduced, a quick motion image is reproduced at the double speed. In the example illustrated in FIG. 10, the data is thinned out and recorded so that the frame rate of the recorded video image actually becomes twice the original frame rate. However, the frame rate can be converted using other methods which do not affect the result of the present invention.

The video recording and reproducing apparatus according to the present exemplary embodiment includes the recording mode 1 and the recording mode 2 similarly as the first exemplary embodiment and can similarly switch between the modes. The operations performed in the recording mode 2 will be described below.

A recording time t in the recording mode 2 can be a unique setting value of the apparatus or can be selected from a plurality of setting values. When the video image is recorded at the normal speed, the apparatus automatically stops recording after the time t elapsed from start of recording. The lengths of all video images recorded as described above thus become the time t.

On the other hand, if the video image is to be recorded at N times the normal speed, the reproduction time becomes t*N when recording is performed for the time t. The video image is thus recorded by calculating a recording time t′ using the equation 1 so that the reproduction time of the video image to be recorded becomes the time t. For example, when the video image is to be recorded in a condition that the recording time at the normal speed is 8 seconds and the actual recording frame rate has become double, the recording time t′ of the video image in the recording mode 2 becomes 8/2=4 seconds. Restrictions can be applied as necessary to the setting range of the actual recording frame rate and switching between the recording mode 1 and the recording mode 2. Since the content is similar to that of the first exemplary embodiment, description will be omitted.

In a third exemplary embodiment of the present invention, information indicating that it is necessary to convert the frame rate is recorded instead of converting the frame rate when the video image is recorded. When the video image is reproduced, the video recording and reproducing apparatus recognizes that it is necessary to convert the frame rate and then reproduces the video image by converting the frame rate. The video recording and reproducing apparatus according to the third exemplary embodiment thus includes a speed changing unit which changes the number of frames recorded per unit time by performing frame conversion when the recorded video data is reproduced. A method for setting video recording time of the video recording and reproducing apparatus according to the third exemplary embodiment will be described below.

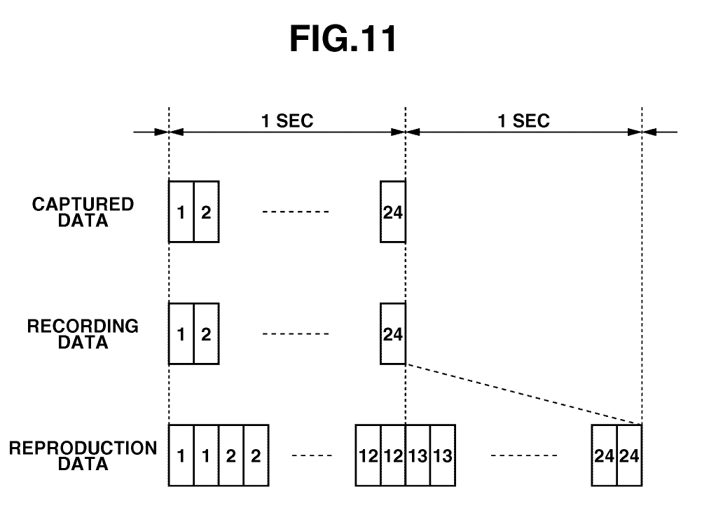

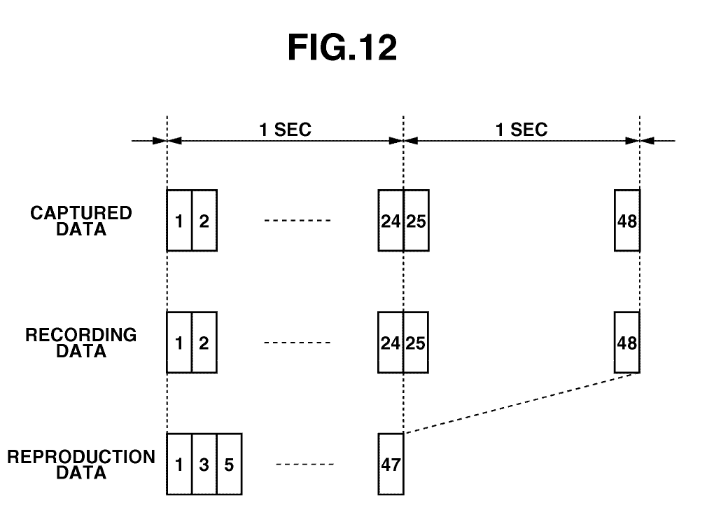

FIG. 11 illustrates a frame configuration when a video image to be reproduced in slow motion at half the speed is recorded and reproduced. Further, FIG. 12 illustrates a frame configuration when a video image to be reproduced in quick motion at double speed is recorded and reproduced.

According to the present exemplary embodiment, the frame rate 1, the frame rate 2, and the frame rate 3 are the same values. In FIGS. 11 and 12, “captured data” is data transferred from the camera signal processing unit 2 to the recording signal processing unit 6. Further, “recording data” is data recorded by the recording signal processing unit 6, and “reproduction data” is data read out by the reproducing signal processing unit 7 to reproduce the video image.

Referring to FIG. 11, the frame rates of the captured data, the recording data, and the reproduction data are 24 fps. The recording signal processing unit 6 records the same amount of data as the captured data in and reads out the data a plurality of times when reproducing the data, so that the amount of reproduction data becomes twice the amount of the recording data. This indicates that the actual frame rate has become half the original frame rate, and when the data is reproduced, the video image is reproduced in slow motion at half the speed. In such a method, it is necessary to record determination data at the same time as recording the data, for determining that the recorded data is the video image to be reproduced at half the speed. The determination data may be recorded as management information or may be recorded in other recording areas. In either case, the reproduction speed can be changed by checking the determination data when the recorded data is reproduced. In the example illustrated in FIG. 11, the data is read out a plurality of times so that the frame rate of the reproduced video image actually becomes half the original frame rate. However, the frame rate can be converted using other methods such as interpolating the data, which do not affect the result of the present invention.

Referring to FIG. 12, the frame rates of the captured data, the recording data, and the reproduction data are 24 fps. The recording signal processing unit 6 records same amount of data as the captured data and thins out the data when reproducing the data, so that the amount of reproduction data becomes half the amount of the recording data. This indicates that the actual frame rate has become double the original frame rate, and when the data is reproduced, the video image is reproduced in quick motion at the double speed. In such a method, it is necessary to record the determination data at the same time as recording the data, for determining that the recorded data is the video image to be reproduced at the double speed. The determination data may be recorded as management information or may be recorded in other recording areas. In either case, the reproduction speed can be changed by checking the determination data when the recorded data is reproduced. In the example illustrated in FIG. 12, the data is thinned out and recorded so that the frame rate of the reproduced video image actually becomes double the original frame rate. However, the frame rate can be converted using other methods, which do not affect the result of the present invention.

The video recording and reproducing apparatus according to the present exemplary embodiment includes the recording mode 1 and the recording mode 2 similarly to the first exemplary embodiment and can similarly switch between the modes. The operations performed in the recording mode 2 will be described below.

A recording time t in the recording mode 2 can be a unique setting value of the apparatus or can be selected from a plurality of setting values. When the apparatus records the video image at the normal speed, the apparatus automatically stops recording after the time t elapsed from start of recording. The lengths of all video images recorded as described above thus become the time t.

On the other hand, if the video image is to be recorded at N times the normal speed, the reproduction time becomes t*N when recording is performed for the time t. The video image is thus recorded by calculating a recording time t′ using the equation 1 so that the reproduction time of the video image to be recorded becomes the time t. For example, when the video image is to be recorded in a condition that the recording time at the normal speed is 8 seconds and the actual recording frame rate has become double, the recording time t′ of the video image in the recording mode 2 becomes 8/2=4 seconds. Restrictions can be applied as necessary to the setting range of the actual recording frame rate and switching between the recording mode 1 and the recording mode 2. Since the content is similar to that of the first exemplary embodiment, description will be omitted.

The present invention can also be achieved by providing a storage medium which stores software (program code) for implementing functions of the above-described exemplary embodiments, to a system or an apparatus. The program code stored in the storage medium can be read and executed by a computer (central processing unit (CPU) or micro-processing unit (MPU)) of the system or the apparatus.

In this case, the software (program code) itself realizes the novel functions of the above-described exemplary embodiments. The software (program code) itself and the storage medium which stores the software (program code) constitute the present invention.

The storage medium can be, for example, a flexible disk, a hard disk, an optical disk, a magneto-optical (MO) disk, a compact disc read-only memory (CD-ROM), a CD-recordable (CD-R), a CD-rewritable (CD-RW), a magnetic tape, a nonvolatile memory card, or a ROM.

Further, the above-described exemplary embodiments can be realized by executing software (program code) read by a CPU. An operating system (OS) or the like working on a computer can also perform a part or the whole of actual processing according to instructions of the software (program code) and realize functions of the above-described exemplary embodiments.

Furthermore, software (program code) read from a storage medium can be stored in a memory equipped in a function expansion board inserted in a computer or a function expansion unit connected to a computer, and a CPU in the function expansion board or the function expansion unit can execute all or a part of the processing based on the instructions of the software (program code) to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-097107 filed Apr. 13, 2009, which is hereby incorporated by reference herein in its entirety.

What is claimed is:

1. An apparatus comprising:
a recording unit configured to record in a recording mode in which recording is started by a recording start instruction and is stopped after a predetermined recording time elapses;
a changing unit configured to change a number of frames to be recorded per unit time; and
a setting unit configured to set, when an image recorded in the recording mode is reproduced, the predetermined recording time according to a reproduction speed so that reproduction time of the image becomes constant.

2. The apparatus according to claim 1, wherein the image to be recorded is reproduced in slow motion.

3. The apparatus according to claim 1, wherein the image to be recorded is reproduced in quick motion.

4. The apparatus according to claim 1, further comprising a setting unit configured to set a number of frames to be changed by the changing unit.

5. The apparatus according to claim 1, wherein when the predetermined recording time set in the recording mode exceeds a predetermined range, a restriction is applied on a setting range of the changing unit.

6. The apparatus according to claim 1, further comprising a second recording unit configured to perform a second recording mode in which recording is started by a recording start instruction and is stopped by a recording stop instruction.

7. The apparatus according to claim 6, wherein switching from the second recording mode to the recording mode is prohibited when the predetermined recording time set in the recording mode exceeds a predetermined range.

8. The apparatus according to claim 6, wherein the recording mode switches to the second recording mode when the predetermined recording time set in the recording mode exceeds a predetermined range.

9. A method comprising:
recording in a recording mode in which recording is started by a recording start instruction and is stopped after a predetermined recording time elapses;
changing a number of frames to be recorded per unit time by a changing unit; and
setting, when a video image recorded in the recording mode is reproduced, the predetermined recording time according to a reproduction speed so that reproduction time of the image becomes constant.

10. The method according to claim 9, wherein the image to be recorded is reproduced in slow motion.

11. The method according to claim 9, wherein the image to be recorded is reproduced in quick motion.

12. The method according to claim 9, further comprising setting a number of frames to be changed by the changing unit.

13. The method according to claim 9, wherein when the predetermined recording time set in the recording mode exceeds a predetermined range, a restriction is applied on a setting range of the changing unit.

14. The method according to claim 9, further comprising performing a second recording mode in which recording is started by a recording start instruction and is stopped by a recording stop instruction.

15. The method according to claim 14, wherein switching from the second recording mode to the recording mode is prohibited when the predetermined recording time set in the recording mode exceeds a predetermined range.

16. The method according to claim 14, further comprises switching the recording mode to the second recording mode when the predetermined recording time set in the recording mode exceeds a predetermined range.

17. A computer readable storage medium storing a computer-executable program of instructions for causing a computer to perform a method comprising:
recording in a recording mode in which recording is started by a recording start instruction and is stopped after a predetermined recording time elapses;
changing a number of frames to be recorded per unit time by a changing unit; and
setting, when a video image recorded in the recording mode is reproduced, the predetermined recording time according to a reproduction speed so that reproduction time of the image becomes constant.

18. The computer readable storage medium according to claim 17, wherein the image to be recorded is reproduced in slow motion.

19. The computer readable storage medium according to claim 17, wherein the image to be recorded is reproduced in quick motion.

20. The computer readable storage medium according to claim 17, further comprising setting a number of frames to be changed by the changing unit.
